(19) United States
(12) Patent Application Publication
(10) Pub. No.: US 2010/0313455 A1
(43) Pub. Date: Dec. 16, 2010

(54) ADVERTISING SHEET LAMINATE

(76) Inventor: SE-KWON KIM, Goyang-si (KR)

Correspondence Address: ROBERT W. J. USHER;PATENT AGENT, 1133 BROADWAY, #1515, NEW YORK, NY, 10010, US

(21) Appl. No.: 12/483,235

(22) Filed: Jun. 11, 2009

(51) Int. Cl. G09F 7/12; B32B 37/00; B32B 38/14; B32B 38/04; G09F 7/00

(52) U.S. Cl. 40/594; 156/60; 156/277; 156/252; 40/615

(57) ABSTRACT

An advertising sheet laminate which for attachment to signboards or windows. The advertising sheet has good print quality to very clearly display advertising contents, has increased light transmission to appear lighter than a prior art advertising sheet, and at the same time, has greatly increased tensile strength to extend the life span thereof. The advertising sheet is formed by bonding a first polyvinyl chloride (PVC) sheet, which is printed with a predetermined advertisement, to one side of a polyethylene terephthalate (PET) sheet using an adhesive, and then pressing the bonded PET sheet and first PVC sheet under heat.

### FIELD OF THE INVENTION

The present invention relates to an advertising sheet laminate for display by attachment to signboards or windows, and more particularly to an advertising sheet laminate which has good print quality to very clearly display advertising contents, has increased light transmission to appear lighter than a prior art advertising sheet laminate, and at the same time, has greatly increased tensile strength to extend the life span thereof.

### BACKGROUND OF THE INVENTION

Generally, as shown in FIG. 1, an advertising sheet 10 for signboards according to the prior art is manufactured by bonding polyvinyl chloride (PVC) sheets 11 and 12 to respective opposite sides of a net-like, polyester yarn fabric 13, and printing a predetermined advertisement on the surface of either of the two PVC sheets 11 and 12.

More specifically, the advertising sheet 12 is manufactured by inserting the polyester yarn fabric 13 between the two PVC sheets 11 and 12, and then heating the layered structure to a temperature between about 200 and 230 degrees Centigrade so as to bond the layers together.

Alternatively, depending on the kind of printer, the advertising sheet may also be manufactured by thermally bonding a separate sheet 14 printed with a predetermined advertisement to exposed surfaces of either of the two PVC sheets 11 and 12.

The PVC sheets 11 and 12 serving as printing surfaces are easy to handle and exhibit excellent application adaptability and, therefore, are widely used in signboards of both small and large sizes. Particularly, they are easy to install and, after installation, are more attractive than other signboard materials and do not exhibit bending phenomena caused by shrinkage and swelling. Thus, they attract a great deal of attention from consumers.

Also, because the PVC material has excellent flexibility and can be formed into a gel state, a sheet can be manufactured by a calender process.

However, in the prior art advertising sheet 10, because the polyester yarn fabric 13 is interposed between the two PVC sheets 11 and 12 by a thermal lamination process, the net-like polyester yarn fabric 13 is visible through the PVC sheets 11 and 12.

When viewing the advertising sheet 10 close-up, images of the net-like polyester yarn fabric 13 and the printed advertisement overlap or are superimposed/merge with each other, such that the printed advertisement is not clearly visible. In addition, the net-like polyester yarn fabric 13 screens out light from a lamp installed in the signboard and thus the advertisement generally appears comparatively dark. Also, because the polyester yarn fabric 13 has a net-like structure, the tensile strength of the advertising sheet 10 is greatly weakened.

Furthermore, when an advertising sheet is attached a window or the like to display advertisements, the environment outside the window cannot be seen well as a result of the presence of the attached advertising sheet.

### SUMMARY OF THE INVENTION

The present invention has been made to obviate the above-mentioned problems occurring in the prior art, and it is an object of the present invention to provide an advertising sheet laminate which has good print quality to very clearly display advertising contents, has increased light transmittance to appear lighter than the prior art advertising sheet laminate, and at the same time, has greatly increased tensile strength to extend the life span thereof.

Another object of the present invention is to provide an advertising sheet laminate for attachment to windows, which has a plurality of through-holes formed therein, such that the advertising surface is visible outdoors and the environment outside the window having the advertising sheet laminate attached thereto is visible indoors through the holes in the sheet laminate.

To achieve the above objects, in one aspect, the present invention provides an advertising sheet laminate for attachment to signboards or windows, which is formed by bonding a first polyvinyl chloride (PVC) sheet, which is printed with a predetermined advertisement, to one side of a polyethylene terephthalate (PET) sheet using an adhesive, and then pressing the bonded PET sheet and first PVC sheet under heat.

In another aspect, the present invention also provides an advertising sheet laminate for attachment to signboards or windows, which is constructed by bonding a first polyvinyl chloride (PVC) sheet, which is printed with a predetermined advertisement, to one side of a polyethylene terephthalate (PET) sheet using an adhesive, pressing the bonded PET sheet and first PVC sheet under heat, and then forming a plurality of through-holes at a constant interval so as to perforate the bonded PET sheet and first PVC sheet.

In still another aspect, the present invention provides an advertising sheet laminate for attachment to signboards or windows, which is constructed by bonding a first PVC sheet and a second PVC sheet to opposite sides of a PET sheet using an adhesive, and then pressing the bonded PET sheet, first PVC sheet and second PVC sheet under heat.

In yet another aspect, the present invention provides an advertising sheet laminate for attachment to signboards or windows, which is constructed by bonding a first PVC sheet and a second PVC sheet to opposite sides of a PET sheet using an adhesive, pressing the bonded PET sheet, first PVC sheet and second PVC sheet under heat, and then forming a plurality of through-holes at a constant interval so as to perforate the bonded PET sheet, first PVC sheet and second PVC sheet.

The invention includes the advertising sheet laminate per se and a method for making the advertising sheet laminate.

As used herein, a laminate comprises a plurality of layers having respective adjacent sides intimately bonded together in overlying relation by the application of heat and pressure.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the construction of a prior art advertising sheet;

FIG. 2 shows the construction of an advertising sheet laminate according to a first embodiment of the present invention;

FIG. 3 shows the construction of an advertising sheet laminate according to a second embodiment of the present invention;

FIG. 4 shows the construction of an advertising sheet laminate according to a third embodiment of the present invention;

FIG. 5 shows the construction of an advertising sheet laminate according to a fourth embodiment of the present invention;

FIG. 6 shows the construction of an advertising sheet laminate according to a fifth embodiment of the present invention; and

FIG. 7 shows the construction of an advertising sheet laminate according to a sixth embodiment of the present invention.

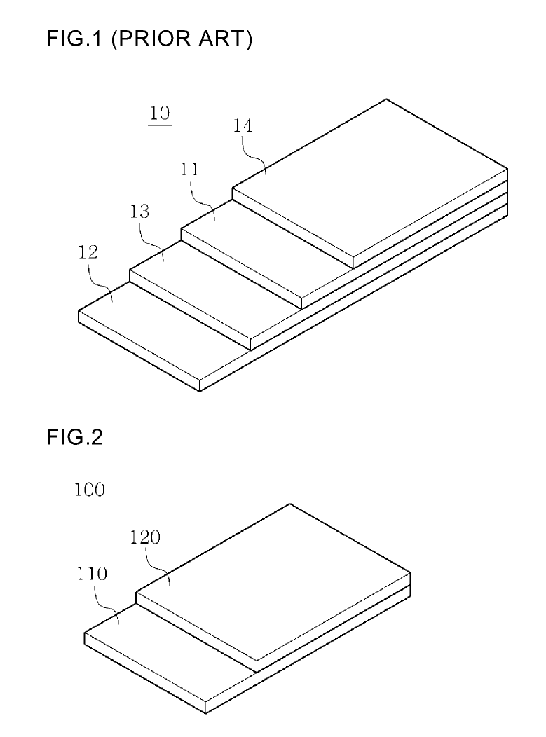

### DETAILED DESCRIPTION OF THE INVENTION

Hereinafter, preferred embodiments of the present invention will be described in further detail with reference to the accompanying drawings.

FIG. 2 shows the construction of an advertising sheet laminate according to a first embodiment of the present invention.

As shown therein, an advertising sheet laminate 100 according to the first embodiment of the present invention is formed by bonding a first PVC sheet 120 to one side of a PET (polyethylene terephthalate) sheet 110 using adhesive, and then pressing the bonded PET sheet and first PVC sheet under heat.

Herein, the heat pressing is carried out by passing the bonded PET sheet 110 and first PVC sheet 120 through rollers in which a temperature of about 100 degrees centigrade is generated.

The first sheet 120 is printed with a predetermined advertisement.

Also, the PET material forming the PET sheet 110 is linear polyester which is the most widely used kind of commercially available polyester and has excellent transparency, heat resistance, durability and chemical resistance.

Specifically, when the PET sheet 110 is made of the PET material, it has not only impact resistance very superior to that of glass or acrylic resin, but also very excellent processability, transparency and surface gloss, and thus an advertising sentence printed on the first PVC sheet 120 is more clearly visible. In addition, it has a very high light transmittance so as to appear lighter than the prior art polyester yarn fabric used previously, and, at the same time, the tensile strength thereof is greatly enhanced.

Also, when a color is imparted to the PET sheet 110, a more elegant advertising effect can be displayed.

Meanwhile, a coating layer made of PVC resin for facilitating solvent ink-jet printing can further be applied to the surface of the first PVC sheet 120 of the advertising sheet 100.

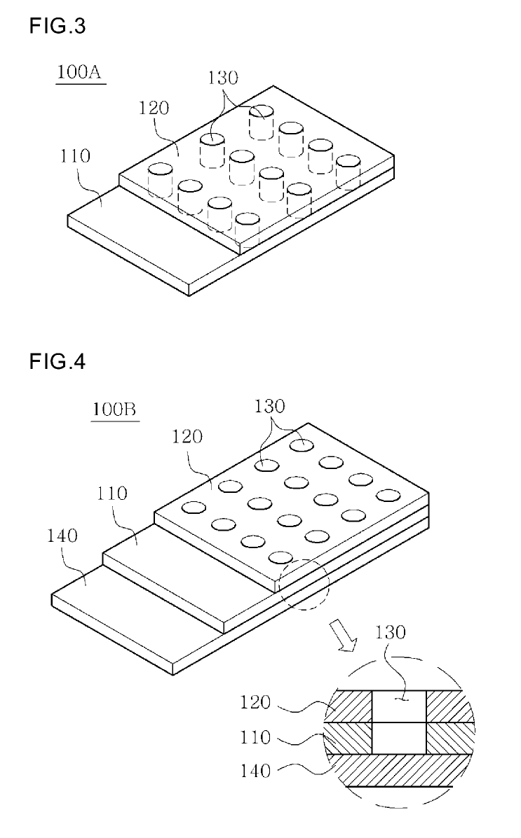

FIG. 3 shows the construction of an advertising sheet laminate according to a second embodiment of the present invention.

As shown therein, an advertising sheet 100A according to the second embodiment of the present invention is constructed by bonding a first PVC sheet 120 to one side of a PET sheet 110 using adhesive, pressing the bonded PET sheet 110 and first PVC sheet 120 under heat, and then forming a series of through-holes at constant intervals so as to perforate the bonded PET sheet 110 and first PVC sheet 120.

Herein, the first PVC sheet 120 is printed with a predetermined advertisement.

Also, the heat pressing is carried out by passing the bonded PET sheet 110 and first PVC sheet 120 through rollers in which a heat of about 100 degrees centigrade is generated.

The advertising sheet laminate 100A thus constructed is attached to windows or the like. The advertising sheet laminate 100A exhibits the following effects: the environment outside a window attached with the advertising sheet laminate is visible through the through-holes 130 of the advertising sheet laminate 100A from the inside of a room in which the advertising sheet laminate is located, and the inside of the room is not visible outside the window due to the advertising sheet laminate 100A.

In order to improve such effects, in addition to forming the through-holes 130, the portion of the first PVC sheet 130, which is printed with an advertisement, is constructed to have a white color, and one side of the PET sheet 110 which is visible indoors is constructed to have a black color, whereby the reflection and absorption of light are used.

FIG. 4 shows the construction of an advertising sheet laminate according to a third embodiment of the present invention.

As shown therein, an advertising sheet laminate 100B according to the third embodiment of the present invention has a structure in which a release paper 140 is further attached to one side of the PET sheet 110 of the advertising sheet laminate 100A according to the second embodiment, by an adhesive.

The attachment of the release paper 140 is performed in order to provide easy handling and facilitate attachment to windows or the like.

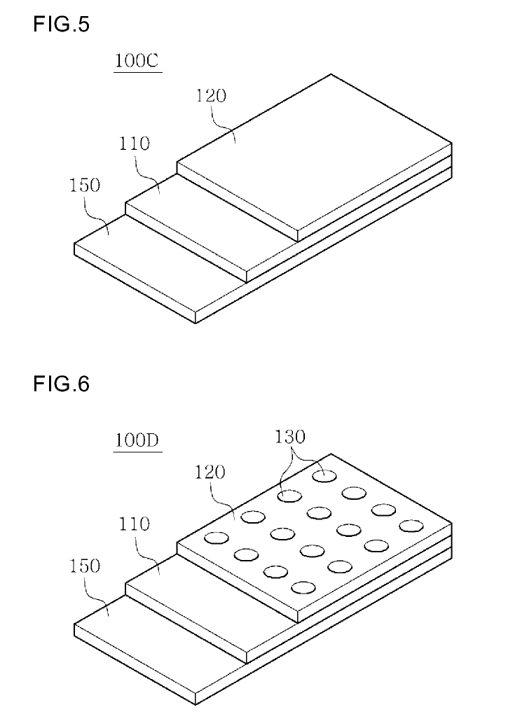

FIG. 5 shows the construction of an advertising sheet laminate according to a fourth embodiment of the present invention.

As shown therein, an advertising sheet laminate 100C according to the fourth embodiment of the present invention is constructed by bonding a first PVC sheet 120 and a second PVC sheet 150 to opposite sides of a PET sheet 110 using adhesive, and then pressing the bonded PET sheet, first PVC sheet and second PVC sheet under heat.

Herein, one side of the first PVC sheet 120 or the second PVC sheet 150 is printed with a predetermined advertisement.

Also, the heat pressing is carried out by passing the bonded PET sheet 110, first PVC sheet 120 and second PVC sheet 150 through rollers in which a heat of about 100 degrees centigrade is generated.

The advertising sheet laminate 100C according to the fourth embodiment of the present invention exhibits the same effects as those described in the first embodiment, while the tensile strength thereof is further improved.

Also, in the advertising sheet laminate 100C according to the fourth embodiment of the present invention, each of the first PVC sheet 120 and second PVC sheet 150 of the advertising sheet laminate can be replaced by a polyurethane (PU) sheet.

The PU sheet has good elasticity and good cold resistance.

Alternatively, in the advertising sheet laminate 100C according to the fourth embodiment of the present invention, each of the first PVC sheet 120 and second PVC sheet 150 of the advertising sheet can also be replaced by a polyethylene (PE) sheet.

The PE sheet is dust repellent such that dust or the like do not adhere well thereto, and thus, the printed surface is prevented from being sullied.

FIG. 6 shows the construction of an advertising sheet laminate according to a fifth embodiment of the present invention.

As shown therein, an advertising sheet laminate 100D according to the fifth embodiment of the present invention is constructed by bonding a first PVC sheet 120 and a second PVC sheet 150 to opposite sides of a PET sheet 110 using an adhesive, pressing the bonded PET sheet 110, first PVC sheet 120 and second PVC sheet 50 under heat, and then forming a plurality of through-holes at a constant interval so as to perforate the bonded PET sheet 110, first PVC sheet 120 and second PVC sheet 50.

Herein, one side of the first PVC sheet 120 or the second PVC sheet 150 is printed with a predetermined advertisement.

Also, the heat pressing is carried out by passing the bonded PET sheet 110, first PVC sheet 120 and second PVC sheet 50 through rollers in which a heat of about 100 degrees Centigrade is generated.

The advertising sheet laminate 100D thus constructed is an advertising sheet laminate which is attached to windows or the like. It has the same effects as those described in the second embodiment of the present invention and differs from the second embodiment in that it has increased tensile strength.

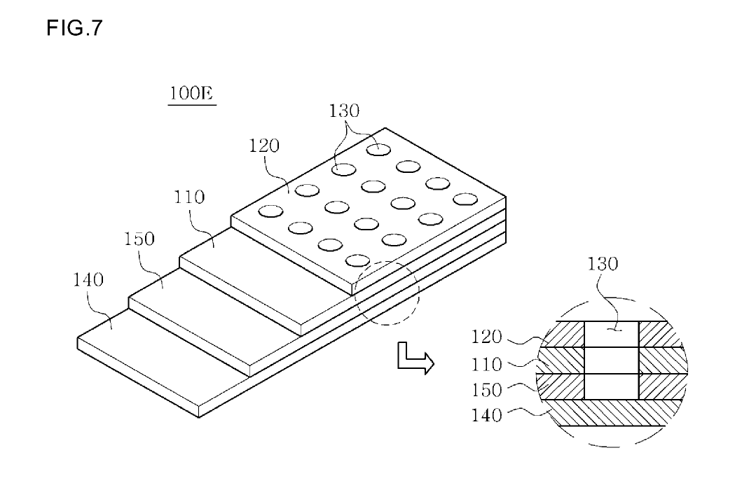

FIG. 7 shows the construction of an advertising sheet laminate according to a sixth embodiment of the present invention.

As shown therein, an advertising sheet laminate 100E according to the sixth embodiment of the present invention has a structure in which release paper 140 is further bonded to one side of the first PVC sheet 120 or second PVC sheet 150 of the advertising sheet laminate 100D, according to the fifth embodiment of the present invention using adhesive.

The attachment of the release paper 140 is for ease of handling, and the advertising sheet laminate 100E is used after removing the release paper 140.

As described above, according to the present invention, the net-like polyester yarn fabric 3 is not used, and thus, the phenomenon in which the shape of the net-like polyester yarn fabric 13 is projected to overlap/merge with the advertisement printed on the PVC sheet is prevented, thereby providing a more clear and distinct print quality.

Also, the present invention provides advantages in that light transmission through the advertising sheet laminate can be increased such that the advertising surface feels lighter than the prior art advertising sheet laminate and in that the tensile strength of the advertising sheet laminate can be improved.

In addition, when the advertising sheet laminate of the present invention is attached to a window, the advertising surface is visible from outside the window, and the environment outside the window is visible from indoors. Thus, the advertising sheet laminate of the present invention eliminates the trapped feeling occurring because the environment outside the window is not visible.

Although the preferred embodiments of the present invention have been described for illustrative purposes, those skilled in the art will appreciate that various modifications, additions and substitutions are possible, without departing from the scope and spirit of the invention as disclosed in the accompanying claims.

1. An advertising sheet laminate for attachment to signboards or windows comprising:
a first polymer sheet with an advertisement print thereon,
a polyethylene terephthalate (PET) sheet underlying one side of the first polymer sheet, and
an adhesive bond between respective adjacent sides of the sheets;
wherein the polymer comprises one of polyvinyl chloride (PVC), polyurethane (PU) and polyethylene (PE).

2. An advertising sheet laminate according to claim 1 wherein the polymer of the first sheet comprises PVC and has a side surface with a coating layer of PVC resin for facilitating solvent inkjet printing.

3. An advertising sheet laminate according to claim 1 wherein a series of through-holes extend through respective opposite sides thereof at constant intervals so that the advertising sheet laminate is sufficiently transparent for an light environment outside a room window to which the advertising sheet laminate is attached to be visible through the sheet from an inside of the room but the inside of the room is not visible through the sheet from outside.

4. An advertising sheet laminate according to claim 3 wherein a portion of the first sheet, which carries the advertisement is white and, one side of the PET sheet is black.

5. An advertising sheet laminate according to claim 3 comprising a release paper adhering to another side of the PET sheet.

6. An advertising sheet laminate for attachment to signboards or windows comprising:
a first polymer sheet and a second polymer sheet, the polymer comprising one of polyvinyl chloride (PVC), polyurethane (PU) and polyethylene (PE);
and a polyethylene terephthalate(PET) sheet between said first and said second sheets.

7. An advertising sheet laminate according to claim 6 wherein a series of through-holes extending through respective opposite sides thereof at constant intervals so that the advertising sheet laminate is sufficiently transparent for a light environment outside a room window to which the advertising sheet laminate is attached to be visible through the sheet from an inside of the room but the inside of the room is not visible through the sheet from outside.

8. An advertising sheet laminate according to claim 7 comprising a release paper adhering to one of an exposed side of the first sheet and an exposed side of the second sheet.

9. A method for making an advertising sheet laminate for attachment to signboards or windows comprising the steps of:
providing a first sheet printed with a predetermined advertisement and made of one of polyvinyl chloride (PVC), polyurethane (PU) and polyethylene (PE);
providing a polyethylene terephthalate (PET) sheet;
bonding with adhesive the first sheet to one side of the polyethylene terephthalate (PET) sheet; and
pressing the bonded sheets together under heat.

10. The method according to claim 9, wherein the heat pressing is carried out by passing the bonded sheets through rollers in which a temperature of 100 degrees centigrade is generated.

11. The method according to claim 9, in which the first printed sheet is PVC and is provided by the steps of coating one surface with a layer of PVC resin for facilitating solvent inkjet printing and printing the advertisement on the coated surface.

12. The method according to claim 9, comprising the step of perforating the bonded PET sheet and first PVC sheet at constant intervals to provide a series of through-holes extending therethrough from side to side at constant intervals so that the advertising sheet laminate is sufficiently transparent for a light environment outside a room window to which the advertising sheet laminate is attached to be visible through the sheet from an inside of the room but the inside of the room is not visible through the sheet from outside.

13. The method according to claim 12, wherein a portion of the first sheet, which is printed with the advertisement, is white and, one side of the PET sheet is black.

14. The method according to claim 12, comprising the step of adhering a release paper to another side of the PET sheet using an adhesive.

15. A method for making an advertising sheet laminate for attachment to signboards or windows comprising the steps of:
providing a first sheet of one of PVC, PU and PE;
providing a second sheet of one of PVC, PU and PE;
providing a PET sheet;
bonding by adhesive the first sheet and the second sheet, respectively, to respective opposite sides of the PET sheet; and
pressing the bonded PET sheet, first sheet and second sheet together under heat.

16. The method according to claim 15, comprising the step of perforating the bonded PET sheet and the first and the second sheets at constant intervals to provide a series of through-holes extending therethrough from side to side at constant intervals so that the advertising sheet laminate is sufficiently transparent for a light environment outside a room window to which the advertising sheet laminate is attached to be visible through the sheet from an inside of the room but the inside of the room is not visible through the sheet from outside.

17. The method according to claim 16, comprising the step of adhering, by adhesive, a release paper to one of an exposed side of the first sheet and an exposed side of the second sheet.
